(19) United States
(12) Patent Application Publication
(10) Pub. No.: US 2022/0356375 A1
(43) Pub. Date: Nov. 10, 2022

(54) DENSITY ADJUSTABLE LABEL

(71) Applicant: UPM RAFLATAC OY, Tampere (FI)

(72) Inventors: Ismo Pietari, Wroclaw (PL); Marzena SIDELNIK-PATEREWICZ, WROCLAW (PL); Weronika KOT, WROCLAW (PL); Karol GRABINSKI, BIELANY WROCLAWSKIE (PL)

(21) Appl. No.: 17/621,426

(22) PCT Filed: Jun. 25, 2020
(86) PCT No.: PCT/FI2020/050460

§ 371 Date: Dec. 21, 2021

(30) Foreign Application Priority Data
Jun. 28, 2019 (FI) 20195581

(51) Int. Cl. C09J 7/21; C09J 7/38; C09J 7/35; C09J 11/08

(52) U.S. Cl. CPC C09J 7/21; C09J 7/385; C09J 7/35; C09J 11/08; C09J 2203/334; C09J 2301/408; C09J 2301/302; C09J 2301/304; C09J 2400/283; C09J 2433/00

(57) ABSTRACT

The specification relates to a density adjustable label and a label laminate (8) for providing the same. Further, the specification concerns a combination of a label (1) and an item (100), as well as a method for manufacturing the label laminate (8). The label (1) comprises a face layer (2) and an adhesive layer (4). The face layer (2) comprises natural fibre based material. The adhesive layer (4) comprises pressure sensitive adhesive and at least one additive for adjusting total density of the label. The pressure sensitive adhesive comprises acrylic polymer(s). The additive comprises expandable particles, the label is detachable from a surface labelled at washing conditions having temperature in a range of 60-90° C. or above and the detached label is arranged to float on a washing liquid.

### TECHNICAL FIELD

This specification relates to a label and a label laminate, as well as to uses of such. Further, the specification concerns a combination of a label and an item, as well as a method for producing a label laminate.

### BACKGROUND

It is general practice to apply a label to the surface of containers, such as bottles made of polymer or glass, to provide decoration, identification and/or information, for example, on the contents of the container. The use of polymer containers, for example bottles made of thermoplastic polymers, has been increasing. One of the most popular polymer for used in bottles is polyethylene terephthalate (PET). The containers, such as bottles in the beverage industry, are generally re-used or recycled and thus there is a need for labels which are easily removed from the surface of the container during washing processes such as hot dilute caustic soda. Especially there is an interest to make the recycling of polymeric containers more efficient and cost effective. Thus, removable labels are an important topic, for example, in beverage industry as well as in the future for other end use applications wherein labels are to be removed to improve the recyclability of the labelled items or the label materials themselves. Different new type of recycling methods are continuously being developed but the easiest to use are the ones which have already been widely adopted and in use. One important example of such recycling processes is the aforementioned wash off process using hot, typically caustic, washing liquid to separate the labels from the labelled items.

It would be desirable to produce labels which are economical but also environmentally friendly. Further it would be desirable that the labels are removable from a surface of an item allowing efficient recycling of the item. As an example, remnants or deposits of labels, such as adhesive, print ink and label face, may interfere the recycling process of PET. Remnants may cause problems with colour, clarity and processability of the recycled PET. Paper labels in general may cause issues on the plastic recycling due to the impurities from the paper fibres and the adhesive.

### SUMMARY

It is an aim of this specification to provide a density adjustable label. The density of the label may be adjusted in such a way that the label is arranged to float on a liquid. Floating on the liquid allows the label and/or an item labelled with the label to be recycled efficiently.

According to an embodiment, a label comprising a face layer and an adhesive layer is provided. The face layer comprises natural fibre based material and the adhesive layer comprises pressure sensitive adhesive and at least one additive for adjusting total density of the label. The pressure sensitive adhesive comprises acrylic polymer(s). The additive comprises expandable particles, the label is detachable from a surface labelled at washing conditions having temperature in a range of 60-90° C. or above and the detached label is arranged to float on a washing liquid.

According to an embodiment, a label laminate comprising a face layer, an adhesive layer and a release liner is provided. The face layer is adjoined to the release liner via the adhesive layer. The face layer comprises fibre based material and the adhesive layer comprises pressure sensitive adhesive and at least one additive for adjusting total density of the label laminate. The pressure sensitive adhesive comprises acrylic polymer(s). The additive comprises expandable particles and a label comprising the face layer and the adhesive layer is detachable from a surface labelled at washing conditions having temperature in a range of 60-90° C. or above and the detached label is arranged to float on a washing liquid.

According to an embodiment, a method for manufacturing a label laminate according to this specification is provided. The method comprises the following steps of:
arranging a substrate as a release liner or a face layer,
coating the substrate with a pressure sensitive adhesive and
laminating the release liner together with the face layer in such a way that the pressure sensitive adhesive is arranged in between the face layer and the release liner.

The method further comprises
including the at least one additive into the adhesive layer.

According to an embodiment, a labelled item comprising an item and a label according to this specification is provided. The label is attached to a surface of the item through the adhesive layer of the label.

### BRIEF DESCRIPTION OF THE DRAWINGS

FIG. 1 illustrates, by way of an example, a 3D view of a label according to an embodiment,

FIG. 2 illustrates, by way of an example, a cross sectional view of cut labels attached to a common release liner,

FIG. 3 illustrates, by way of an example, a label attached to an item,

FIG. 4 illustrates, by way of an example, a label removed from the surface of an item.

The figures are schematic. The figures are not in particular scale.

Any embodiments, examples or figures that are not directly according to the invention, are presented in order to enable better understanding of the invention and related areas.

### DETAILED DESCRIPTION

The solution is described in the following in more detail with reference to some embodiments, which shall not be regarded as limiting.

In this description and claims, the percentage values relating to an amount of a material are percentages by weight (wt. %) unless otherwise indicated. Term “comprising” may be used as an open term, but it also comprises the closed term “consisting of”. Unit of thickness expressed as microns corresponds to μm. Unit of temperature expressed as degrees C. corresponds to ° C. The following reference numbers and denotations are used in this specification:

| MRK1 | graphics |
|---|---|
| Sx, Sy, Sz | 3D coordinates |
| 1 | label |
| 2 | face layer |
| 4 | adhesive layer |
| 6 | release liner |
| 8 | label laminate |
| 10 | backing material |
| 12 | release layer |
| 100 | item |
| 101 | labelled item |

A label is a piece of material to be applied onto items of different shapes and materials. An item may also be called an article. An item may a package, such as a bottle. A label comprises at least a face material also referred to as a face stock, a face or a face layer. A typical way to adhere the label onto an article is by use of adhesive. The label comprising an adhesive layer is referred to as an adhesive label. The adhesive may comprise pressure sensitive adhesive (PSA). A label comprising pressure sensitive adhesive may be referred to as a pressure sensitive adhesive label. Pressure sensitive adhesive labels may be referred to as self-adhesive labels. The labels comprising PSA can be adhered to most surfaces through an adhesive layer without the use of a secondary agent, such as a solvent, or heat to strengthen the bond. The PSA forms a bond when pressure is applied onto the label at ambient temperature (e.g. between 15 and 35° C.) or for cold applications even under freezing temperatures below 0° C., adhering the label to the item to be labelled. Examples of pressure-sensitive adhesives include water based (water-borne) PSAs, solvent based PSAs and solid PSAs. Solid PSAs are melted during application to the surface to be coated and may also be referred to as hot-melt PSAs. A label may further comprise other adhesive(s).

A wash-off label, also referred to as a washable label, refers to a label removable (detachable) from the surface of the item attached to during subsequent washing process. A wash-off label may comprise an adhesive layer sensitive to washing conditions.

An adhesive sensitive to washing conditions refers to adhesives, wherein the adhesion of the adhesive decreases at washing conditions. The adhesive sensitive to washing conditions is able to reduce its adhesion (tackiness) in washing conditions. The washing conditions generally comprise alkaline conditions and/or increased temperature. Preferably the adhesion of the adhesive to the labelled item decreases more than the adhesion to the face layer so that the adhesive remains attached to the face layer. The increased temperature may be at least 50° C., for example 65° C., 75° C., 80° C., or 90° C. The alkaline conditions refer to an aqueous solution containing alkaline agent, such as NaOH, KOH or combination thereof. Probably the most common alkaline agent is sodium hydroxide (NaOH), which is also called caustic soda. The alkaline conditions (i.e. the alkaline liquid) generally contains about 0.5-10% or 1-4% (by weight) of the alkaline agent(s), for example about 2%.

As an example, a label laminate comprises a face layer, a PSA layer, and further a release liner. The face layer and the release liner are typically laminated together having the adhesive layer in between, which laminated structure is referred to as a label laminate. The release liner is used for protecting the adhesive layer but also for allowing easier handling of the label up to the point of labelling wherein the label face layer is dispensed and adhered to a surface of an item. In labelling the release liner is removed and disposed of. A wash-off label laminate refers to a label laminate structure comprising e.g. PSA layer sensitive to washing conditions and wherein the adhesion of the adhesive decreases at washing conditions so as to allow removal of the label from the surface labelled. The label laminate may be a continuous structure from which the individual labels may be die-cut.

As an example, a label is a linerless self-adhesive label. Linerless label webs or labels are provided to users without release liner over the adhesive layer. Elimination of release liners reduces the material costs of the labels but also avoids the disposal of the release liner after the labelling. Moreover, the exclusion of the release liner decreases the thickness in a roll of labels and more labels can be provided per roll.

Labels may be used in wide variety of labelling applications and end-use areas, such as beverage labelling, food labelling, home and personal care product labelling, and labelling of industrial products. The surface of the labelled article may be for example plastic, glass, metal, or paper based. The labelled article may be for example a container, such as a bottle, jar, canister, can, tin or the like. The label may also be applied to semi-rigid or flexible packages used for e.g. packaging of food. Examples of articles include glass bottles, metal bottles, polyethylene terephthalate (PET) bottles, and bottles made of polyolefin, such as high density polyethylene (HDPE) and polypropylene (PP). The label may surround the labelled article, such as a bottle, completely or partially.

Term “face layer” refers to a top layer of the label, also called as a face stock or a face material. The face layer is the layer that is adhered to the surface of an item during labelling through an adhesive layer. The face layer may comprise e.g. printing in order to provide information and/or visual effect, such as information of the content of the item labelled. Printable face layer is suitable for printing by any of the known printing methods, such as with gravure, flexographic process, offset, screen or letter-press. The printing may exist on a top surface, reverse side or both top and reverse side of the face layer. Further, the label may contain additional layers, for example top coatings or overlaminates to protect the top surface and/or print of the label against rubbing or other external stress. A label consisting of a face layer, printing layer and an adhesive layer may be referred to as a printed label.

Term “release liner” refers to a structure comprising a backing material layer as a substrate and a release coating layer on a surface of the substrate. In other words, the backing material is usually coated with a thin layer of release agent, such as silicone or non-silicone based agent. The release coating layer provides a non-adherent surface i.e. low adhesion and release effect against the adhesive layer. The release liner protects the adhesive layer during shipment and storage. It further allows for efficient handling of individual labels after the labels are die-cut and the surrounding matrix is stripped up to the point wherein the individual labels are dispensed on a labelling line. During dispensing the release liner is peeled off and discarded.

Label Structure

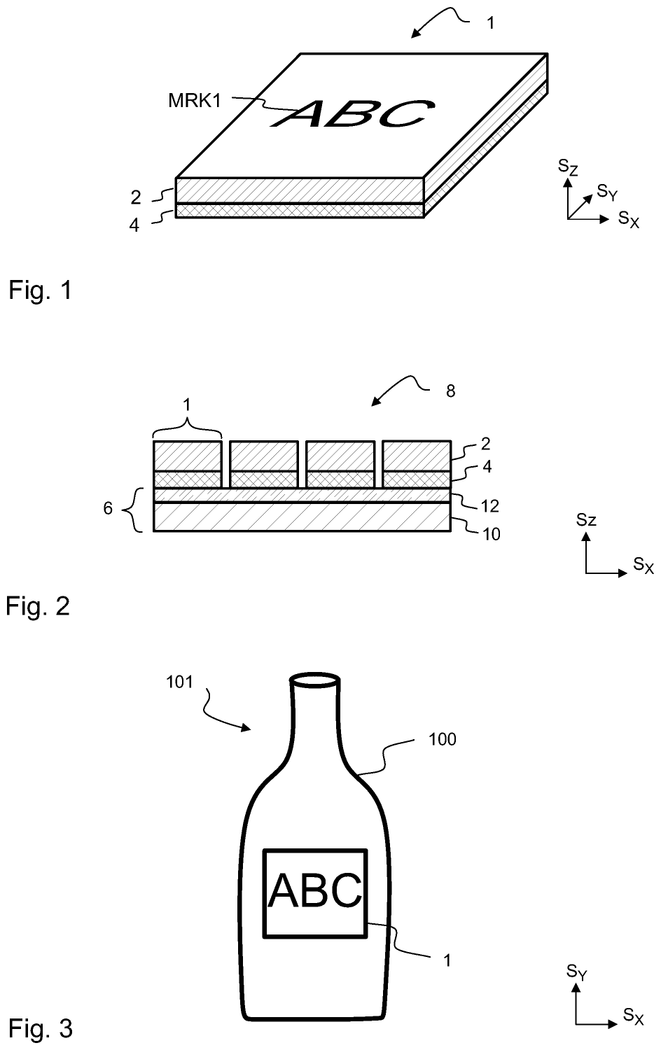

Referring to FIG. 1 a label 1 comprises a face layer 2 and an adhesive layer 4. The label 1 is attachable to an item 100 through the adhesive layer 4. Further the label 1 typically includes graphical patterns MRK1 on its face layer 2. During label manufacturing, continuous face layer 2 is laminated together with a release liner 6 having the adhesive layer 4 in between so as to provide a label laminate 8 from which the individual labels 1 can be cut. Term “label laminate” 8 refers to a continuous structure comprising a face layer 2, an adhesive layer 4 and a release liner 6. Individual labels 1 may be die-cut from the continuous label laminate 8. A label laminate 8 illustrated in FIG. 2 comprises four cut labels 1 attached to a common release liner 6. The release liner 6 has a backing material 10 coated with a release layer 12. During labelling the release liner 6 is removed and the label 1 is attached onto the surface to be labelled through the adhesive layer 4.

FIG. 2 presents an example embodiment of a label laminate 8 comprising four cut labels 1 attached to a common release liner 6. The label laminate structure may comprise a face layer 2, a release liner 6 and an adhesive layer 4. The adhesive layer 4 is arranged between a release layer 12 of the release liner 6 and the face layer 2. Referring to FIG. 1, the label structure may further comprise printing MRK1. A top surface of the face layer 2 may be printed. The printing may be subsequently top coated in order to protect the printing. Alternatively or in addition, the reverse side of the face layer 2, adjacent to the adhesive layer 4, may be printed so that this print is visible through transparent adhesive layer 4 when release liner 6 is attached and label is not yet dispensed onto an article or is removed from the article. In some embodiments, the adhesive layer 4 may also be printable.

The label 1 may further comprise a primer layer. The primer layer may be arranged in between the face layer 2 and the adhesive layer 4. The primer layer may enhance compatibility of adjacent layers or parts of the label. The primer layer may enhance the adhesive anchorage to the face layer. The primer layer may also act as a barrier preventing adhesive components from migrating into the face layer. Depending on the wash-off recycling process in question, it may be preferable that after the label has been removed from the labelled item the adhesive still remains attached to the label face material. This may facilitate easier collection of the label materials preventing the contamination of the washing liquid/solution and alleviating need to refresh the liquid/solution.

According to an embodiment, the label 1 comprises at least one additive. The at least one additive may be used for adjusting total density of the label. The additive is included in at least one of the layers comprised by the label 1. The additive may be included in more than one layers of the label 1. The label 1 may comprise more than one additives. One layer of the label 1 may comprise only one additive or more than one additives.

According to an embodiment, the additive is included in an adhesive layer 4.

According to an embodiment, the label 1 is arranged to float on a liquid. The liquid may refer to an aqueous solution. The liquid may refer to water. The water may be pure water. The liquid may refer to a washing liquid. The washing liquid may be pure water. The washing liquid may be aqueous solution containing alkaline agent. The alkaline agent may be for example NaOH, KOH or combination thereof.

According to an embodiment, density of the label is equal to or below 1 g/cm³ after being immersed in aqueous solution. The density of the label is equal to or below 1 g/cm³ for a wetted label. The density of the label refers to a total density of the label.

According to an embodiment, the total density of the label experiences change from higher than 1 g/cm³ to below 1 g/cm³ when the label is being immersed in hot aqueous solution. The temperature of the washing solution may be at least 75 degrees C., or more than 85 degrees C. or even more than 95 degrees C.

According to an embodiment the total density of the label experiences change from higher than the density of the washing solution to lower than the density of the washing solution, when the label is being effected by, e.g. immersed in, hot aqueous solution and the density of the washing solution is determined at the actual washing temperature. The temperature of the washing solution may be at least 75 degrees C., or more than 85 degrees C., or even more than 95 degrees C. The density of the washing solution at these temperatures may be slightly above 1 g/cm³, for example above 1.03 g/cm³, above 1.05 g/cm³ or above 1.07 g/cm³; and typically below 1.10 g/cm³.

According to an embodiment the total density of the label experiences change from higher than the density of the washing solution to lower than the density of the washing solution, when the label is being effected by, e.g. immersed in, hot aqueous solution and the density of the washing solution is determined at the actual washing temperature. The temperature of the washing solution may be at least 75 degrees C., or more than 85 degrees C., or even more than 95 degrees C. The density of the washing solution at these temperatures may be slightly below 1 g/cm³, for example below 0.98 g/cm³, below 0.96 g/cm³ or below 0.94 g/cm³; and typically above 0.92 g/cm³.

According to an embodiment, the aforementioned heat induced density change is mainly due to the density adjusting additive or additives.

According to an embodiment, the heat induced density change due to the density adjusting additive or additives is irreversible.

According to an embodiment, total density of the label is arranged to decrease when the label 1 is exposed to an aqueous solution and/or heat.

According to an embodiment, total density of the label is at least 1 g/cm³ before being immersed in aqueous solution, i.e. for a dry label.

According to an embodiment, in addition to heat induced density change, the same density adjusting additive or additives will cause heat induced change in the tackiness of pressure sensitive adhesive of the label.

According to an embodiment, the adhesive of the label is a permanent type of pressure sensitive adhesive which without the density adjusting additive or additives does not significantly lose its adhesion when immersed in hot aqueous washing solution.

According to an embodiment, the adhesive of the label is a wash-off type pressure sensitive adhesive which even without the density adjusting additive or additives experiences significant loss in its adhesion when immersed in hot aqueous washing solution.

Arranging the label 1 to float on a liquid allows the plastic item labelled with the above mentioned label to be recycled in a typical manner, in a process described below.

In typical washing and separation processes relating to the recycling of plastic items, such as bottles, the plastic items are exposed to a washing solution and the items in the washing solution are agitated at elevated temperature. The plastic items are typically crushed into flakes before exposing them to the washing solution. After that, the items/flakes are rinsed so as to remove the washing solution. Then, after settling of the material the system comprises floating material on a surface of the rinsing liquid as well as material that has a density higher than the one of the rinsing liquid, thus sinking to the bottom. Thus, the floating material may be separated from the sank material. The sank material typically contains the recyclable plastic items/flakes.

The density of typical printed labels often may be above 1.0 g/cm³, for example 1.15 g/cm³. In a case of labels having a paper based face layer the wetting of label will cause the density of the labels being even higher. A wetted label may for example have a density of 1.19-1.4 g/cm³. The wetting of the label refers to a process wherein the label fibres maintain contact with a liquid, resulting from intermolecular interactions when the two are brought together.

The sink-float process described above typically utilizes liquid having density of about 1.0 g/cm³. In that case the dense labels will sink together with the recyclable plastic items and thus reduce the quality of the recyclates, i.e. the material to be recycled. Depending on the chemical composition and temperature of the washing liquid/solution the density of the washing liquid/solution may deviate slightly form 1.0 g/cm³. For example, water with washing additives, for example alkaline additives, may have density slightly above 1.0 g/cm³. The density of the water based washing solution may be, for example, above 1.03 g/cm³, above 1.05 g/cm³, or above 1.07 g/cm³; and typically below 1.10 g/cm³. On the other hand, the density of the washing solution, especially for a non-water based washing solution, may be slightly below 1 g/cm³, for example below 0.98 g/cm³, below 0.96 g/cm³, or 0.94 g/cm³; and typically below 0.92 g/cm³.

As the density of the label is reduced for making the label 1 to float on a liquid the label can be separated from the other (plastic) recyclates more efficiently. The density of the label may be reduced by using an additive. The additive may comprise for example expandable particles or stable particles.

It is preferable to adjust the amount of the additive so that the density change in the label is just enough to make it float in the washing solution conditions. It is not beneficial to make the density change/difference in the label wider than necessary. That may lead to excessive use of additive(s), which is generally unnecessary and uneconomical. For example, if the additive or additives are incorporated into a pressure sensitive adhesive, then excessive amounts of additive(s) may deteriorate the performance of the adhesive in other respects, such as anchorage or tackiness. According to an embodiment the density of the label remains no more than 0.03 g/cm³ or 0.06 g/cm³, or at most 0.10 g/cm³ below the density of the washing solution when determined at the actual washing temperature.

According to an embodiment, the additive comprises expandable particles. The expandable particles may be capable of reacting for example to heat and/or water by expanding. The purpose of the expandable particles is to reduce the total density of the label. Preferably the total density of the label is reduced to be equal to or below 1 g/cm³ after being immersed in aqueous solution.

The expandable particles may comprise for example thermoplastic microspheres encapsulating gas. In an example a shell of the microsphere is arranged to soften and the gas is arranged to expand when the microsphere is exposed to heat. As a result, an increase in volume of the microsphere is achieved. The expandable particles may be arranged to expand, for example, at temperature of 85° C. or higher.

The expandable particles may have a diameter of from 5 μm to 40 μm in unexpanded state. The particles may be chosen to have a grade with narrower diameter range, for example 5-9, or 18-24, or 25-40 μm. The expandable particles may have a density of from 5 to 30 kg/m³ when expanded. In an example, in an unexpanded state a shell thickness of the microsphere is 2 μm and a diameter of the microsphere is 12 μm. After exposure to heat the shell thickness is 0.1 μm and the diameter is 40 μm. The expansion of the particles when having been activated may be irreversible. The particles may be solvent resistant.

The additive may comprise stable particles. The purpose of the stable particles is to reduce the total density of the label. Preferably the total density of the label is reduced to be equal to or below 1 g/cm³ after being immersed in aqueous solution. Stable particles refers to particles that have substantially unchanging properties in conditions confronted in the label manufacturing as well as in use and recycling of the labels.

The additive may comprise glass bubbles. The glass bubbles may be in a form of a free-flowing powder. The glass bubbles may comprise hollow glass microspheres. They have a high strength-to-density ratio. Preferably, the glass bubbles are made of soda-lime borosilicate glass. The glass bubbles are chemically inert and water resistant. The colour of the glass bubbles may be off-white. The density of the glass bubbles may be for example 0.125-0.6 g/cm³ or 0.125-0.3 g/cm³. Median particle size of the glass bubbles may be for example 18-65 μm.

According to an embodiment, the label 1 may comprise a varnish layer arranged on a top surface of the face layer 2. The varnish may be utilized for example for tuning the printability of the face layer and/or its appearance and/or its tolerance to moisture or wettability (or permeability of water vapour).

The additive for adjusting total density of the label may be included in the varnish. Amount of the additive in the varnish may be for example from 2.5 to 5 wt. % of the total dry weight of the varnish containing the additive.

According to an embodiment, the label 1 may be top coated. A top coat may be arranged on top of the printing. The purpose of the top coat may be to protect the printing from wear/abrasion and/or enhance the gloss or haze depending on the end use application of the label.

The additive for adjusting total density of the label may be included in the top coat. Amount of the additive in the top coat may be for example from 2.5 to 5 wt. % of the total dry weight of the top coat containing the additive.

Face Layer

A face layer 2 of a label 1 may be natural fibre based, such as coated or uncoated paper, plastic film or a combination of these. Natural fibre based face layers 2, in contrast to plastic based, may be preferred, for example due to increasing tendency to reduce the unnecessary use of the plastic materials.

According to an embodiment a face layer 2 is natural fibre based. Preferably the face layer 2 is natural fibre based material that can carry print or a printable layer. For face layers 2 a certain degree of hydrophobicity is a preferred property. Hydrophobicity reduces the wettability of the natural fibre based face layer 2. According to an embodiment the face layer 2 comprises paper.

The face layer may have a substance of for example 80 g/m² or 45 g/m² measured according to an ISO standard 536.

Wettability of the paper may be tested by determining the quantity of water that can be absorbed by the surface of paper in a given time. Water absorptiveness is a function of various paper characteristics such as sizing, porosity, etc. The water absorptiveness may be determined by a so-called Cobb method, namely a standard ISO 535.

According to an embodiment, a face layer 2 has water absorptiveness of from 5 to 30 g/m². According to another embodiment a face layer 2 has water absorptiveness of from 10 to 30 g/m². According to yet another embodiment a face layer 2 has water absorptiveness of from 15 to 25 g/m². According to still another embodiment a face layer 2 has water absorptiveness of from 20 to 25 g/m².

The paper based face layer 2 may comprise wet strength paper. Wet strength paper refers to paper wherein the web of fibres holding the paper together resist a force of rupture when the paper is wet. Wet strength of paper may be expressed as a ratio of wet to dry tensile force at break. Various techniques, such as refining of the pulp and wet pressing on the paper machine can be used to reduce the strength loss of the paper upon wetting.

Chemicals may be used for improving the wet strength. The use of chemicals can retain as much as 10% to 30% of the original dry strength of the paper. The wet strength chemicals may improve the dry strength of the paper as well. The wet strength chemicals may include for example wet strength resins or neutral sizing agents. Wet strength resins include for example urea-formaldehyde (UF), melamine-formaldehyde (MF) and polyamide-epichlorohydrin (PAE). Neutral sizing agents include for example alkylketene dimers (AKD) and alkenylsuccinic anhydride (ASA).

Improved wet strength may also be obtained by coating a polymer onto the paper.

Use of the wet strength paper in a face layer 2 of a label 1 has the effect that disintegration of the paper fibres in the washing conditions is decreased. Thus, defibration of the labels and ending up of the sticky fibres to the sank materials is diminished.

Alternatively, the paper based face layer 2 may comprise thermal paper. Thermal paper refers to a special fine paper that is coated with a material formulated to change colour when exposed to heat.

The face layer 2 may comprise at least one additive. The at least one additive may be used for adjusting total density of the label. The total density of the label may be reduced by using an additive in the face layer 2. The additive may comprise for example expandable particles or stable particles as described above. The additive may be included into the face layer 2 already during the papermaking process. Alternatively, the additive may be included in a top coat of the face layer 2. Yet alternatively, the additive may be included in a varnish of the face layer 2.

The face layer 2 may comprise both stable particles and expandable particles.

Adhesive Layer

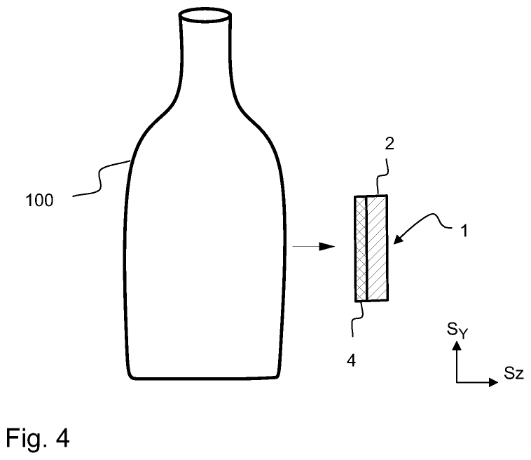

A label 1 can be affixed to the surface of an item (article) 100 through an adhesive layer 4 so as to form a labelled item 101, as illustrated in FIGS. 3 and 4. Adhesive layer 4 provides adhesion i.e. adheres or bonds the label 1 to the surface of the item 100. The adhesive layer 4 of the label 1 should have a suitable adhesion i.e. tack (stickiness) in order to stick to an item 100 during labelling process. Tack is the property of adhesive that allows the immediate formation of a bond on contact with another surface. The tackiness is needed at the point the label is attached to an item 100. The optimum adhesion between two materials depends on, for example, the wetting and surface energy of the materials. The adhesive may be permanent or removable. The adhesive may be a wash-off adhesive designed to experience significant change in tackiness when immersed in hot aqueous, alkaline washing liquid.

An adhesive layer 4 may be a continuous coating covering 100% of the face layer surface. Alternatively, it may be applied discontinuously as spots or strips covering less than 100% of the face layer surface. This may be called “pattern gumming”. For example, the adhesive may cover between 10 to 90% of the total area of the face layer 2. Reduced amount of adhesive may have effect on reducing the time needed for the subsequent removal of the label during washing process from the surface of the item attached.

An adhesive layer 4 may have a thickness in the range of about 5-40 μm, or in the range of about 5-20 μm. For example, the thickness of the adhesive layer is in the range of about 10-20 μm or 15-20 μm. A coat weight of the adhesive layer, in dry weight, may be in the range of about 5-40 g/m², or 5-20 g/m². The coat weight of the adhesive may be preferably less than 25 g/m², or equal to or less than 20 g/m². For example, the coat weight of the adhesive layer is between 10 and 20 g/m² or between 15 and 20 g/m². In an example, the coat weight of the adhesive layer is 16.5 g/m².

As a rule of thumb, the adhesive coating thickness is related to the coat weight of the adhesive in such a way, that generally coat weight of 1 g/m² corresponds to coating thickness of ˜1 μm or slightly less.

According to an embodiment, an adhesive layer 4 adjacent to the surface of the item labelled comprises a pressure sensitive adhesive(s) (PSA). The adhesive layer 4 may comprise at least one of the following: water based (water-borne) PSA and hot melt PSA. The adhesive layer 4 may be a monolayer or a multilayer comprising at least two adhesive layers.

According to an embodiment, the adhesive layer 4 comprises at least one additive. The at least one additive is used for adjusting total density of the label. The total density of the label may be reduced by using an additive in the adhesive layer 4. The additive comprises expandable particles as described above. The additive may be an additive capable of reacting to heat and/or water by expanding.

The additive comprising expandable particles has the effect that the expansion caused by the heat and/or water facilitates removal of the label from the labelled surface. Expanding of the particles may cause lifting of the adhesive and thus the label from the surface it has been adhered to. This is particularly advantageous in case of permanent adhesive having itself no significant wash-off properties.

According to an embodiment, amount of the expandable particles in the adhesive layer 4 may be from 0.1 to 5.0 wt. %, 0.5 to 2.5 wt. % or 0.5 to 1.0 wt. % of the dry weight of the adhesive. According to an embodiment, the amount of the expandable particles may be up to 15 wt. % of the dry weight of the adhesive. The amount of the expandable particles may be for example from 5 wt. % to 15 wt. %, such as 7 wt. % of the dry weight of the adhesive.

The expandable particles are preferred, as in comparison to the stable particles they replace less adhesive materials from the adhesive layer 4. Thus they may have smaller effect on the adhesive properties of the adhesive layer.

The adhesive layer 4 may comprise both stable particles and expandable particles.

The adhesive layer 4 may comprise both an additive capable of reacting to heat and/or water by expanding as well as an additive comprising glass bubbles.

The expandable particles may be included in the adhesive layer 4 after drying of the adhesive layer 4. The adhesive is typically dried at a temperature of about 100° C. In a case the expandable particles were added before drying the particles would expand unnecessary early and thus cause the adhesive to lose its adhesive properties.

Alternatively, the expandable particles may be included in the adhesive layer 4 before drying of the adhesive layer. In that case the adhesive may be dried in such temperatures that the expansion of the expandable particles already while drying is avoided.

The stable particles may be included in the adhesive layer 4 at any point of the label/label laminate manufacturing process.

According to an embodiment, the adhesive comprising expandable particles is arranged to be pre-activated at a high temperature before the washing process. In the pre-activation step the label, i.e. the face layer and the adhesive layer therein may be exposed to a temperature of at least 95° C., preferably 100° C. for at least one minute. The pre-activation causes the expandable particles of the adhesive to expand. The pre-activation step may be performed for example as part of a sorting process prior to the washing process. After the pre-activation, the label may be floatable in a room temperature water.

The adhesive layer 4 includes adhesive comprising acrylic polymer(s). The amount of acrylic polymer(s) in the adhesive (in dry weight) may be for example from 45 to 90 wt. %, preferably from 45 to 70 wt. %. The adhesive may further comprise at least one of: a surfactant or a wetting agent, a tackifier, a plasticizer, a thickener or a viscosity agent, a filler. The filler may be for example silica, clay and/or calcium carbonate. The tackifier may be for example hydrocarbon resin, rosin ester resin and/or rosin acid resin. Further, the adhesive may comprise at least one of: a pH stabilizer, a defoamer, a stabilizer.

In an example, the adhesive layer 4 includes permanent adhesive comprising acrylic dispersion. The adhesive is washable with water, preferably hot water. Best washability may be obtained with hot alkaline water. The required washing time depends on the labelled surface, time after the application of the label and the washing conditions. Water absorption properties of the face layer strongly influence the washability properties of the adhesive layer of the label. Printing ink used as well as the method of printing also influences the wash-off time. The adhesive may have a tack of 15 N/25 mm when measured according to FINAT test method FTM 9.

In an example, the adhesive layer 4 includes an acrylic, water-borne wash-off adhesive. The adhesive is washable in hot (70-80° C.) alkaline water. The hot alkaline water may comprise for example 1.5-2.5 wt. % NaOH. The adhesive may have a tack of 15 N/25 mm when measured according to FINAT test method FTM 9. Water absorption properties of the face layer of the label strongly influence the wash-off time of the label. Full cover printing, varnishing and foiling can affect wash-off performance.

In an example, the adhesive layer 4 includes a water-based PSA formulation (also referred to as water-borne adhesive composition) comprising acrylic polymers (polyacrylate(s)). Water-based PSA formulation comprising acrylic polymers may also be referred to as acrylic, water-borne PSA.

In an example a water-based PSA formulation comprises a dispersion comprising cross-linked alkyl acrylate(s) (polyacrylate(s)) dispersed in water. For example, a water-based PSA formulation comprises an aqueous dispersion of polymer(s) based on acrylic ester(s). Solids content of the aqueous dispersion may be between 50 and 70%, or between 65 and 70%, when measured according to standard DIN EN ISO 3251. An amount of polyacrylate(s), i.e. polymer(s) based on alkyl acrylic ester(s), in the PSA composition may be, in dry weight, between 60 and 90 wt. %, preferably between 60 and 85 wt. %, between 70 and 85%, or between 70 and 80 wt. %.

The water-based PSA formulation further comprises pressure polymerized vinyl acetate ethylene copolymer(s) (VAE). An amount of pressure polymerized vinyl acetate ethylene copolymer(s) in the pressure sensitive adhesive composition may be, in dry weight, between 10 and 40 wt. % or between 15 and 30 wt. %.

In an example the water-based PSA formulation further comprises surfactant(s). The adhesive formulation may further comprise at least one of the following modifiers: tackifier and plasticizer. Tackifier may be at least one of the following: hydrocarbon resin, rosin ester resin, rosin acid resin and terpene resin. Plasticizer may be at least one of the following: DINCH (di-isononylcylic hexanedicaboxylate), benzoate, adipate and citrate. In addition, the adhesive formulation may comprise thickener(s) and/or pH adjusting agent(s), such as NaOH and ammonia. Total amount of modifier(s) may be between 1-20 wt. %.

In an example, the adhesive layer 4 comprises solid PSA, i.e. hot melt PSA sensitive to washing conditions. The solid PSA may be cross linkable hot melt, such as UV curable hot melt. UV curable hot melts are applied in molten state to the surface to be coated and subsequently cured by UV light in order to form cross-linked structure. In an example PSA sensitive to washing conditions is UV curable acrylic based hot-melt adhesive.

In an example the adhesive layer sensitive to washing conditions comprises a polymer composition curable with ultra violet radiation (UV). A base polymer of the UV curable PSA may be acrylate. Acrylate may be one of the following: 2-ethylhexyl acrylate (EHA) and butyl acrylate. The polymer composition curable with ultraviolet radiation further includes photoinitiator(s) i.e. ultraviolet radiation initiator. The base polymer structure e.g. the acrylate structure may include the photoinitiator(s). Alternatively, the photoinitiator(s) may be added separately to the adhesive layer composition. An amount of UV curable polymer composition may be between 80 and 99 wt. %.

Primer Layer

A primer layer arranged between the face layer 2 and the adhesive layer 4 may be utilized to enhance the adhesion between the face layer 2 and the adhesive layer 4.

With increasing amount of the expandable particles in the adhesive layer 4 the adhesive anchorage to the face layer 2 is getting worse. Therefore, arranging a primer layer between the face layer 2 and the adhesive layer 4 may enhance the adhesion between the face layer 2 and the adhesive layer 4.

A primer layer may comprise or consist of a primer sensitive to a temperature of the washing process. The temperature of the washing liquid may be between 60 and 90 degrees C., or between 65 and 85 degrees C. Alternatively or in addition a primer layer may comprise or consist of a primer sensitive to an alkaline washing liquid. Washing liquid may be 1-4%, preferably 1-2% alkaline water i.e. alkaline aqueous solution comprising caustic soda, such as sodium hydroxide. A primer layer comprising or consisting of a primer sensitive to a temperature of the washing process and/or alkaline washing liquid may dissolve in the liquid. Alternatively, the primer layer may be dispersible in the washing liquid. The primer layer may be dispersed or dissolved in less than 5 minutes.

The primer layer may comprise one of the following: thermal wax, cellulose derivative, such as carboxy methyl cellulose CMC or modified starch, dextrin, casein, polyvinyl alcohol PVA, ethylene acrylic acid EAA, and acrylic polymer (polyacrylate) with high carboxylic acid content. High carboxylic acid content of the acrylic polymer may provide controlled water solubility.

The primer layer may applied for example by roll coating onto the surface of the face layer.

The primer layer may comprise at least one additive. The at least one additive may be used for adjusting total density of the label. The total density of the label may be reduced by using an additive in the primer layer. The additive may comprise for example expandable particles or stable particles as described above. The additive may be an additive capable of reacting to heat and/or water by expanding or the additive may comprise glass bubbles.

The primer layer may comprise both stable particles and expandable particles.

Label Laminate

According to an embodiment, a label laminate 8 comprising a face layer 2 and an adhesive layer 4 as described above is provided. The label laminate 8 further comprises a release liner 6. The face layer 2 is adjoined to the release liner 6 via the adhesive layer 4. The face layer 2 comprises fibre based material. The adhesive layer 4 comprises pressure sensitive adhesive and at least one additive for adjusting total density of the label laminate. The additive comprises expandable particles. A label comprising the face layer 2 and the adhesive layer 4, and detachable from the label laminate 8 is detachable from a surface labelled at washing conditions having temperature in a range of 60-90° C. and the detached label is arranged to float on a washing liquid. Alternatively, the label may be detachable from a surface labelled at washing conditions having temperature above 90° C.

The additive of the label laminate 8 may comprise stable particles. The additive may comprise glass bubbles.

In an example a volume of the stable particles used may constitute from 40 to 45 vol-% of the total volume label laminate. In that case a total density of 0.97 g/cm³ may be obtained for the label laminate comprising the stable particles.

The label laminate 8 may further comprise a primer layer arranged in between the face layer 2 and the adhesive layer 4.

The face layer 2 of the label laminate 8 may comprise wet strength paper or thermal paper.

The pressure sensitive adhesive of the label laminate 8 may comprise water based adhesive or hot melt adhesive.

The face layer 2 of the label laminate 8 may be varnished.

Method for Manufacturing a Label Laminate

A method for manufacturing a label laminate 8 as described above is provided. The method comprises arranging a substrate as the release liner 6 or the face layer 2, coating the substrate with a pressure sensitive adhesive and laminating the release liner 6 together with the face layer 2 in such a way that the pressure sensitive adhesive is arranged in between the face layer 2 and the release liner 6. The method further comprises including the at least one additive into adhesive layer 4.

1. A label comprising a face layer and an adhesive layer, wherein
the face layer comprises natural fibre based material and has water absorptiveness of from 5 to 30 g/m² when measured according to an ISO standard 535,
the adhesive layer comprises pressure sensitive adhesive, the pressure sensitive adhesive being water based adhesive or hot melt adhesive and comprising acrylic polymer(s), and
at least one additive for adjusting total density of the label,
wherein the additive comprises expandable particles, the label is detachable from a surface labelled at washing conditions having temperature in a range of 60-90° C. or above and the detached label is arranged to float on a washing liquid.

2. The label according to claim 1, wherein the total density of the label is equal to or below 1 g/cm³ after being immersed in an aqueous solution.

3. The label according to claim 1, wherein the label further comprises a primer layer arranged in between the face layer and the adhesive layer.

4. The label according to claim 1, wherein the face layer comprises wet strength paper or thermal paper.

5. (canceled)

6. The label according to claim 1, wherein the face layer is varnished.

7. The label according to claim 1, wherein the label is detachable from a surface labelled at washing conditions having temperature in a range of 65-85° C.

8. The label according to claim 1, wherein the adhesive layer comprising the expandable particles is arranged to be pre-activated prior to exposing to the washing conditions.

9. The label according to claim 8, wherein the adhesive layer comprising the expandable particles is arranged to be pre-activated at a temperature of at least 95° C. for at least one minute.

10. A label laminate comprising a face layer, an adhesive layer and a release liner, the face layer being adjoined to the release liner via the adhesive layer, wherein
the face layer comprises fibre based material and has water absorptiveness of from 5 to 30 g/m² when measured according to an ISO standard 535,
the adhesive layer comprises pressure sensitive adhesive, the pressure sensitive adhesive being water based adhesive or hot melt adhesive and comprising acrylic polymer(s), and
at least one additive for adjusting total density of the label laminate, wherein, the additive comprises expandable particles and a label comprising the face layer, the adhesive layer is detachable from a surface labelled at washing conditions having temperature in a range of 60-90° C. or above and the detached label is arranged to float on a washing liquid.

11. The label laminate according to claim 10, wherein the label laminate further comprises a primer layer arranged in between the face layer and the adhesive layer.

12. The label laminate according to claim 10, wherein the face layer comprises wet strength paper or thermal paper.

13. (canceled)

14. The label laminate according to claim 10, wherein the face layer is varnished.

15. The label laminate according to claim 10, wherein the adhesive layer comprising the expandable particles is arranged to be pre-activated prior to exposing to the washing conditions.

16. The label laminate according to claim 15, wherein the adhesive layer comprising the expandable particles is arranged to be pre-activated at a temperature of at least 95° C. for at least one minute.

17. A method for manufacturing a label laminate according to claim 10, the method comprising the following steps of:
arranging a substrate as a release liner or a face layer,
coating the substrate with a pressure sensitive adhesive and
laminating the release liner together with the face layer in such a way that the pressure sensitive adhesive is arranged in between the face layer and the release liner,
wherein the method further comprises including the at least one additive into the adhesive layer.

18. A labelled item comprising an item and a label according to claim 1, wherein the label is attached to a surface of the item through the adhesive layer of the label.

19. Use of a label according to claim 1 for labelling an item.

20. Use of a label laminate according to claim 10 for providing labels.
